(19) United States
(12) Patent Application Publication
(10) Pub. No.: US 2009/0067194 A1
(43) Pub. Date: Mar. 12, 2009

(54) Light guide with imprinted phosphor

(75) Inventor: Oscar Ozuna Sanchez, Tempe, AZ (US)

Correspondence Address: Paul F. Wille;Cantor Colburn LLP, 55 Griffin Road South, Bloomfield, CT, 06002, US

(73) Assignee: World Properties, Inc., Lincolnwood, IL (US)

(21) Appl. No.: 11/900,355

(22) Filed: Sep. 11, 2007

(51) Int. Cl. F21V 8/00; C03B 37/023; F21V 7/04; F21V 9/16

(52) U.S. Cl. 362/618; 362/629; 65/385; 362/84

(57) ABSTRACT

A light guide includes a transparent sheet exhibiting total internal reflection in at least one direction and phosphor printed on the transparent sheet. The phosphor extracts light from the transparent sheet when the sheet is edge-lit and converts the light from one wavelength to another wavelength. The phosphor is pressed into the surface of the sheet after heating the surface to its softening temperature.

### FIELD OF THE INVENTION

This invention relates to back lights for keypad, keyboards, displays, and other electronic devices (collectively referred to herein as “displays”) and, in particular, to a light guide having phosphor imprinted into at least one major surface of the light guide.

### BACKGROUND OF THE INVENTION

Edge lit sheets have long been known in the art; e.g. U.S. Pat. No. 3,027,669 (Hardesty) and U.S. Pat. No. 3,356,839 (Mehess et al.). Edge lit keypads are also known in the art. For example, U.S. Pat. No. 3,892,959 (Pulles) discloses peripheral cavities for receiving light emitting diodes (LEDs); U.S. Pat. No. 4,177,501 (Karlin) discloses peripheral cavities for receiving light sources; U.S. Pat. No. 4,247,747 (Swatten) discloses LEDs optically coupled to a polyester sheet having a thickness of seven mils (0.18 mm); and U.S. Pat. No. 5,975,711 (Parker et al.) discloses a light conductive panel coupled to a light source.

It has long been known in the art to add phosphorescent or fluorescent materials to a light emitting device for converting some of the emitted light from one wavelength to another; e.g. see U.S. Pat. No. 3,510,732 (Amans). The process is known as cascade; e.g. see U.S. Pat. No. 2,476,619 (Nicoll). It is also known in the art to doubly cascade; e.g. see U.S. Pat. No. 6,023,371 (Onitsuka et al.). In order to produce light at a different wavelength, some light must be absorbed, reducing brightness. A dye simply absorbs light and, although useful, is generally not as desirable as phosphorescent or fluorescent materials.

U.S. Pat. No. 4,183,628 (Laesser et al.) discloses a watch that is backlit by a light source coupled to the edge of a “frost glass” having scratches on its lower surface to redirect light up through a display. U.S. Pat. No. 5,396,406 (Ketchpel) discloses a back light including a light guide edge lit by a uv lamp. Phosphor located in wells in an acrylic “distributor plate” absorbs uv light and emits either red or green or blue light. U.S. Pat. No. 5,550,676 (Ohe et al.) discloses an edge lit light guide having graduated features on a major surface to compensate for distance from the light source. U.S. Pat. No. 5,384,658 (Ohtake et al.), U.S. Pat. No. 5,477,422 (Hooker et al.) and U.S. Pat. No. 6,386,721 (Hosseini et al.) also disclose graduated light scattering features in a light guide. U.S. Pat. No. 6,528,937 (Van Gorkom) discloses (FIGS. 3,4) apparatus for selectively extracting uv light from a light guide and coupling the light through a phosphor overlying the light guide. U.S. Pat. No. 6,717,348 (Takahashi) discloses (FIG. 8) apparatus for selectively extracting light from a light guide and coupling the light through a phosphor overlying the light guide. U.S. Pat. No. 7,036,946 (Mosier) discloses (FIG. 7) a back light for a liquid crystal display. The back light includes a light guide having light extracting elements on a first major surface and a phosphor layer on a second (opposite) major surface. The light extracting elements are not uniformly distributed across the first major surface. A mixture of visible light emitting and uv light emitting LEDs are located at the edge of the light guide. U.S. Published Application 2006/0254894 discloses a light scattering feature on the underside of the light guide and a reflector adjacent the feature.

U.S. Pat. No. 6,428,756 (Barnes) discloses phosphor embedded in the edge of a light guide. An external uv source causes the phosphor to emit visible light into the light guide. Merriam-Webster's Collegiate Dictionary defines “embed” as “to enclose closely in or as if in a matrix <fossils embedded in stone;> . . . to surround closely <a sweet pulp embeds the plum seed>.” The American Heritage Dictionary defines embed as “1. a. To fix firmly in a surrounding mass; b. To enclose in a matrix; 2. To enclose snugly or firmly; 3. To make an integral part of.”

As used herein, “print” means to press into the surface of a sheet. Specifically, phosphor is “printed” on a transparent sheet but does not become surrounded by the sheet. In other words, the phosphor is not embedded in the sheet. Note that phosphor is printed on the surface, not an ink or a medium containing phosphor.

As used herein, “transparent” does not imply a particular level of light transmission. The amount of light transmission that is suitable depends, among other factors, upon the size (largest dimension) of the light guide.

Light guides are a significant improvement over LEDs placed directly behind a display to be back lit. Light guides provide greater uniformity of lighting, reduced thickness, and lower cost. Even so, there can be problems with “hot spots” (glare); for example, where light is coupled to the light guide from a source.

At the edges of a light guide, some of the light does not enter the light guide at an angle necessary for total internal reflection, producing undesirable stray light. Stray light can be absorbed by a mask, a slit, or a collimator at the edge of the light guide but this adds cost.

Typically, a single light guide is used to back light an entire display, which means that the entire display has the same color. Different colored portions of a display must be obtained by the use of dyes, filters, or other means, all of which add to the cost and complexity of the back light.

Light guides of the prior art that include light extraction features are difficult and expensive to change to accommodate a change in design. A simpler, less expensive method for making light guides for back lighting displays is desired.

In view of the foregoing, it is therefore an object of the invention to provide a light guide in which phosphor acts as both a light extracting feature and a light converting feature.

Another object of the invention is to provide a method for locating phosphor on the surface of a light guide.

A further object of the invention is to provide an edge lit light guide having reduced apparent stray light or glare.

Another object of the invention is to provide a light guide having a simpler structure than light guides of the prior art.

A further object of the invention is to provide a light guide that can be produced at lower cost than light guides of the prior art.

### SUMMARY OF THE INVENTION

The foregoing objects are achieved by this invention in which a light guide includes a transparent sheet exhibiting total internal reflection in at least one direction and phosphor printed on the transparent sheet. The phosphor extracts light from the transparent sheet when the sheet is edge-lit and converts the light from one wavelength to another wavelength. The phosphor is pressed into the surface of the sheet.

### BRIEF DESCRIPTION OF THE DRAWINGS

A more complete understanding of the invention can be obtained by considering the following detailed description in conjunction with the accompanying drawings, in which:

FIGS. 1-4 illustrates the steps for making a light guide in accordance with a preferred embodiment of the invention;

FIG. 5 is a cross-section of a light guide constructed in accordance with a preferred embodiment of the invention;

FIG. 6 illustrates the operation of a light guide constructed in accordance with the invention;

FIG. 7 is a cross-section of a display having a light guide constructed in accordance with an alternative embodiment of the invention; and

FIGS. 8-11 illustrates the steps for making a light guide in accordance with an alternative embodiment of the invention.

### DETAILED DESCRIPTION OF THE INVENTION

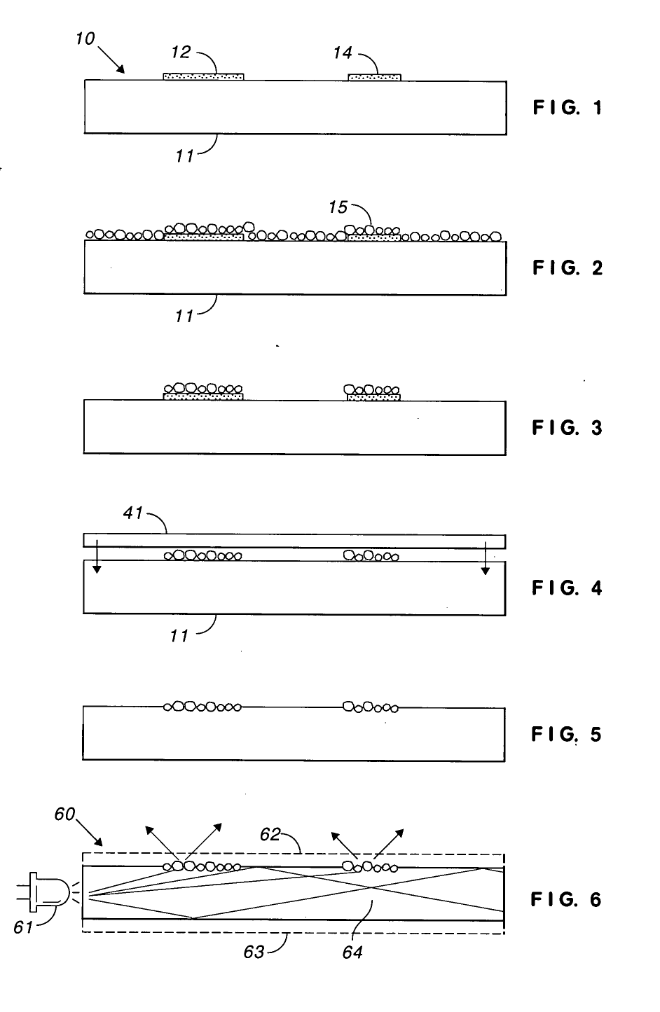

In FIG. 1, light guide 10 includes transparent sheet 11, such as glass or polymer, such as polyvinylidene fluoride (PVDF), polyester, or vinyl; preferably polycarbonate. The thickness of the transparent sheet depends upon application. Light guides have been constructed in accordance with the invention using sheets having thicknesses of 5, 7, and 10 mils (0.13 mm, 0.18 mm, and 0.25 mm). Other thicknesses can be used. The required characteristic is not polycarbonate or thickness but total internal reflection in at least one direction. The term “sheet” is used for convenience. The light guide can be a rod, a cone, a cylinder, or other shape. Any reference to geometrical shape is understood in a physical sense, not in a mathematical sense wherein, for example, a cylinder is a surface, having no thickness.

As known in the art, total internal reflection requires that the index of refraction of the light guide be higher than the index of refraction of the surrounding material. It is known in the art to enhance total internal reflection by cladding the light guide with material having a distinctly lower index of refraction than the light guide. Alternatively, it is known to apply a reflective coating to the light guide to reflect light within the light guide. While technically not total internal reflection, the result is similar and is treated as total internal reflection for this invention.

When total internal reflection is achieved, light is not emitted from a major surface of the light guide. Light extracting “features” must be added to disrupt reflection and cause refraction. In the prior art, such features include roughening the surface of the light guide or forming grooves or other discontinuities in the surface of the light guide. In accordance with one aspect of the invention, phosphor is used as the extracting feature.

In accordance with another aspect of the invention, the phosphor is at least partially uv activated. That is, the phosphor absorbs uv light, and converts the light to a longer wavelength in the visible spectrum. There are many such phosphors known in the art, such as used in fluorescent lamps. Phosphors can be mixed to achieve what appears to be virtually any desired color. (Phosphors emit in discrete lines, not a continuous spectrum as an incandescent lamp does. Thus, a given color can be achieved by mixing two or more distinct colors to make a third color, such as mixing red and green to make yellow.) In one embodiment of the invention, YAG:Ce phosphor (Yttrium Aluminum Garnet (Y₃Al₅O₁₂) doped with cerium) was used.

A desired color can also be achieved by cascading phosphors. For this, one phosphor absorbs uv and emits blue, for example. A second phosphor absorbs blue and emits red, for example. This is not as efficient as direct conversion but is useful.

An adhesive layer, represented by areas 12 and 14, is deposited on sheet 11, preferably by screen printing. A suitable adhesive is “ThreeBond” uv curable adhesive, type 30N-066. Little is used. In one embodiment of the invention, the adhesive layer was deposited to a thickness of approximately one mil (0.025 mm). The purpose of the adhesive is to hold the phosphor in place until printing by making the selected areas tacky. Thickness may vary with adhesive. The minimum effective thickness is preferred.

As illustrated in FIG. 2, phosphor is deposited over the surface of sheet 11. Some portions of the surface are coated with adhesive and some portions are not. Excess phosphor is removed; e.g. by tilting or inverting sheet 11. The phosphor has a particle size greater than two microns and not all particles of phosphor are of the same size. FIG. 3 illustrates light guide 10 after excess phosphor has been removed.

FIG. 4 illustrates the printing step, in which heated platen 41 warms at least the upper surface of transparent sheet 11 to the softening temperature of the sheet. For polycarbonate sheets, a temperature in the range of 120° C.-140° C. has been used successfully. As the upper surface approaches softening temperature, platen 41 pushes the particles of phosphor into the upper surface of sheet 11. The force on the platen depends upon the area of the phosphor being printed.

The particles of phosphor are not embedded in the transparent sheet. Because the particles penetrate or deform the surface of transparent sheet 11, the conditions necessary for total internal reflection do not exist, as illustrated in FIG. 6. But for the phosphor, light traveling inside sheet 11 and incident upon the uneven surface at the location of the phosphor would be refracted. Instead, light incident upon the phosphor is absorbed and is re-emitted at a wavelength different from the wavelength of the incident light.

In accordance with another aspect of the invention, light source 61 is preferably an edge emitting, light emitting diode (LED). Light emitted by an edge emitting LED diverges less than the light from a surface emitting LED. Light source 61 emits uv light and the phosphor converts incident light to visible light. Edge emitting LEDS that emit light at wavelengths of 365, 395, 405, or 460 nanometers are commercially available and suitable for use in the invention. Stray light is invisible and of low intensity. Optional protective layers 62 and 63 have an index of refraction less than sheet 64. A suitable material is vinylidene fluoride resin, such as sold under the name Kynar Flex 2500-20 “Superflex.”

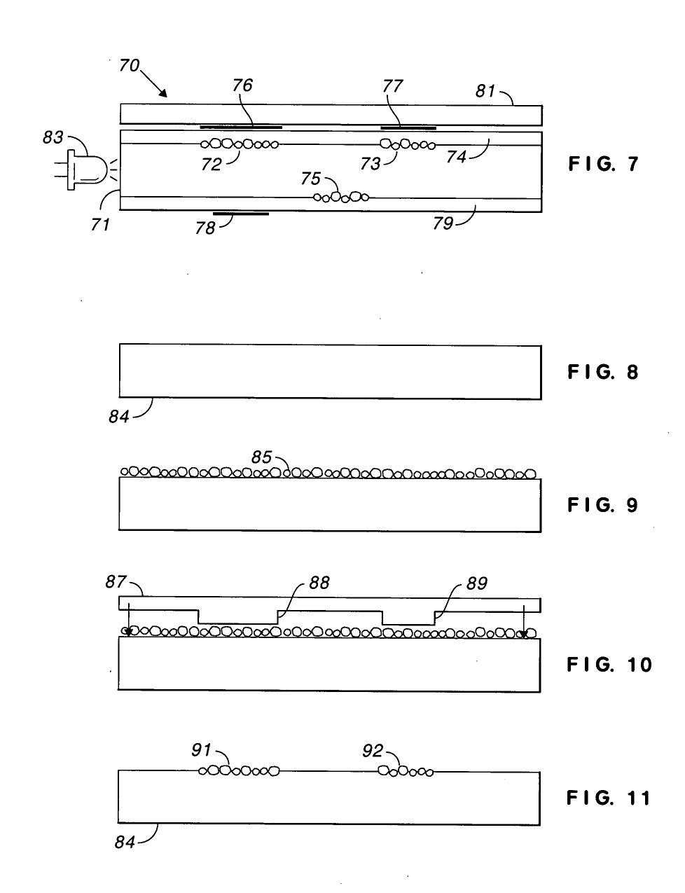

FIG. 7 illustrates a display having a back light with phosphor imprinted on two surfaces. Display 70 includes transparent sheet 71 having phosphor areas 76 and 77 imprinted on the upper surface thereof and phosphor area 75 printed on the lower surface thereof. Approximately aligned with phosphor area 72 is graphic 76. Approximately aligned with phosphor area 73 is graphic 77. Graphics 76 and 77 can be formed on a separate layer or printed on protective layer 74. Reflective area 78, such as a thin layer of aluminum foil, is deposited on protective layer 79, e.g. by thermal printing.

In operation, ultraviolet light from source 83 travels between the major surfaces of transparent sheet 71, either directly or by total internal reflection, until it is intercepted by a phosphor particle. The phosphor converts the ultraviolet light into visible light and the visible light is emitted away from a major surface of sheet 71. A reflective layer can be used to cause light to be emitted preferentially from one major surface, such as the upper surface of sheet 71. The light enters display 81, thereby back lighting the display.

FIG. 8 is a cross-section of sheet 84, which will be printed with phosphor in accordance with an alternative embodiment of the invention. As illustrated in FIG. 9, phosphor particles are deposited over the surface of sheet 84. As with the embodiment of FIG. 2, the phosphor has a particle size greater than two microns and not all particles of phosphor are of the same size. The phosphor particles are distributed over the surface of sheet 84 by blade or roller or by spreading from a trough, somewhat like a spreader for lawn seed, and then vibrating the sheet.

FIG. 9 illustrates the printing step, in which heated platen 87 warms at least the upper surface of transparent sheet 84 to the softening temperature of the sheet. Platen 87 is embossed with the desired pattern for the phosphor areas. Specifically, platen 87 includes raised areas 88 and 89 on the underside thereof, corresponding to the areas for printing. As the upper surface approaches softening temperature, platen 87 pushes the particles of phosphor into the upper surface of sheet 84.

The proximity of the raised areas to sheet 84 will raise the temperature of those areas slightly higher than the rest of the surface of the sheet, although the entire surface will be heated. Phosphor will be printed only in the areas defined by raised areas 88 and 89. The particles of phosphor are not embedded in the transparent sheet. The phosphor particles that are not printed on sheet 84 are easily removed by tilting or even by vacuum. FIG. 11 illustrates the resulting light guide with phosphor areas 91 and 92 serving as both light extracting and light converting features.

The invention thus provides a light guide in which phosphor acts as both a light extracting feature and a light converting feature. The light guide has reduced apparent stray light or glare. A novel method is provided for locating phosphor on the surface of a light guide and the light guide has a simpler structure and lower cost than light guides of the prior art. The surface of the light guide is deformed only where the phosphor is imprinted, thereby reducing stray light from the areas of phosphor.

Having thus described the invention, it will be apparent to those of skill in the art that various modifications can be made within the scope of the invention. For example, the phosphor can be adhered to a platen, which prints the phosphor. Rather than adhesive, an electrostatic charge can be used to hold phosphor particles on a surface until the particles are printed on the transparent sheet. The phosphor and adhesive can be combined into an ink and screen printed together in the desired pattern. Heating can be local rather than the entire surface of the light guide. For example, localized laser heating can be used for softening the light guide, thereby making the selected areas tacky. Not every phosphor area need have the same phosphor or mixture of phosphors; that is, each area can produce a unique color. The material used for a light guide is determined by transparency and softening temperature relative to the highest temperature that the phosphor can tolerate. A mask, a slit, or a collimator can be included with a light guide constructed in accordance with the invention. Protective layers can be transparent, translucent, tinted or include graphics or cascading phosphor, in any combination. Although the term “back light” is used in the description, this is for convenience and not a restriction. A light guide constructed in accordance with the invention can be used as a front light. Although the embossed areas on platen 87 are illustrated as having a rectangular cross-section, this is for illustration only. For example, corners can have a radius and the cross-section can be trapezoidal or dove-tail.

What is claimed is:

1. A light guide comprising:
a transparent sheet exhibiting total internal reflection in at least one direction;
phosphor printed on said transparent sheet, said phosphor extracting light from the transparent sheet when the sheet is edge-lit and converting the light from one wavelength to another wavelength.

2. The light guide as set forth in claim 1 wherein said transparent sheet is polycarbonate.

3. The light guide as set forth in claim 1 and further including a light source that emits ultraviolet light.

4. The light guide as set forth in claim 1 wherein said phosphor is a mixture of phosphors.

5. A back lit display comprising:
a display;
a light guide having a major surface facing said display and an edge;
a light source optically coupled to the edge of said light guide; and
phosphor imprinted in said major surface, said phosphor extracting light from the transparent sheet when the sheet is edge-lit by said light source and converting the light from one wavelength to another wavelength.

6. The back lit display as set forth in claim 5 wherein said light guide is polycarbonate.

7. The back lit display as set forth in claim 5 wherein said light source emits ultraviolet light.

8. The back lit display as set forth in claim 5 wherein said phosphor is a mixture of phosphors.

9. The back lit display as set forth in claim 5 wherein said phosphor is located on at least two areas of said major surface.

10. The back lit display as set forth in claim 9 wherein the phosphor in a first area is different from the phosphor in a second area.

11. A method for making a light guide that selectively emits light from a major surface, said method comprising the steps of:
applying phosphor to the surface;
pressing the phosphor into the major surface at selected areas to disrupt reflection at the areas.

12. The method as set forth in claim 11 wherein said applying step is preceded by the step of:
applying an adhesive to at least a portion of the major surface to define a selected area.

13. The method as set forth in claim 12 wherein the step of applying an adhesive includes the step of:
applying an adhesive to several portions of the major surface.

14. The method as set forth in claim 11 wherein said applying step includes the step of applying more than one type of phosphor.

15. The method as set forth in claim 11 wherein said pressing step is preceded by the step of:
heating the surface at least at the selected areas.
